(19) United States
(12) Patent Application Publication
(10) Pub. No.: US 2006/0132572 A1
(43) Pub. Date: Jun. 22, 2006

(54) Liquid ejecting device and method of controlling liquid ejection in liquid ejecting device

(75) Inventors: Seiji Mochizuki, Nagano (JP); Masahiro Nakamura, Nagano (JP); Osamu Kitagawa, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/293,233

(22) Filed: Dec. 5, 2005

(30) Foreign Application Priority Data
Dec. 6, 2004 (JP) P2004-352772

(51) Int. Cl. B41J 2/01

(52) U.S. Cl. 347/104

(57) ABSTRACT

A liquid ejecting head has a plurality of nozzles which are operable to eject liquid toward a medium. A transporter is operable to transport the medium relative to the liquid ejecting head in a first direction. The transporter is provided with a plurality of first holes adapted to receive the liquid that has been ejected toward outside of the medium.

### BACKGROUND OF THE INVENTION

The present invention relates to a liquid ejecting device adapted to eject liquid, and a method of preliminarily discharging the liquid in the liquid ejecting device.

As a liquid ejecting device which ejects liquid to a medium, an ink jet recording device for conducting printing by ejecting ink drops to the medium from a recording head records an image of desired characters and figures, by discharging minute ink drops to the medium from nozzles of the recording head.

Among the ink jet recording devices of this type, there has been such a device that the medium is transported by means of a belt thereby to perform printing on the medium, by employing a line head. When the line head ejects the ink to perform printing on the medium which is being transported by the belt, in case where some nozzles are not used for ejecting the ink, water may be vaporized at openings of the nozzles, and viscosity of the ink may be increased. Under the circumstances, in order to prevent such phenomenon that the ink will not be newly ejected at the next time when the ink must be ejected, it is necessary for the line head of the ink jet recording device to perform preliminary ejection in which the ink is ejected at a determined interval.

Particularly, in order to enhance quality of a printed image, there is a tendency that an amount of color material for the ink is increased. As the amount of the color material has been increased, the viscosity of the ink is likely to be increased, and this preliminarily ejecting action becomes more and more important. In case of the related line head, there has been proposed a method of performing the preliminary ejection of the ink on a perforation of paper or on the paper between pages (for example, JP-A-2002-67346 (Page 11, FIG. 11)).

In the method of preliminarily ejecting the ink disclosed in JP-A-2002-67346, the recording head preliminarily ejects the ink into a plurality of waste areas which are formed around a recording area of paper, thereby to recover the ink ejecting action. For this purpose, in case where there are different sizes of the paper, it is absolutely necessary to provide an extra space for the preliminary ejection between the pages, according to the size of the paper.

Moreover, in case of the media having different sizes, the preliminary discharge cannot be properly performed at an appropriate position on the paper with the nozzles of the line head. Besides, because the extra space for the preliminary ejection must be provided between the pages of the medium, it is impossible to successively print an image of continuous design on a long sheet of paper.

### SUMMARY

It is therefore an object of the invention to provide a liquid ejecting device in which preliminary ejection can be performed in a transporter, in case where liquid is ejected to a medium from a line head while the medium is transported by the transporter, and a method of preliminarily ejecting the liquid in the liquid ejecting device.

In order to achieve the object, according to the invention, there is provided a liquid ejecting device comprising:

a liquid ejecting head, having a plurality of nozzles which are operable to eject liquid toward a medium;

a transporter operable to transport the medium relative to the liquid ejecting head in a first direction, wherein

the transporter is provided with a plurality of first holes adapted to receive the liquid that has been ejected toward outside of the medium.

With this configuration, the nozzles of the liquid ejecting head can perform the preliminary ejection of the liquid through the plurality of the first holes in the transporter. For this reason, it is not necessary for the nozzles to perform the preliminary ejection with respect to the medium, and there is no need for providing, in advance, an extra space for the preliminary ejection in the medium. It is possible to draw an image having a continuous design on a long medium, by ejecting the liquid.

The plurality of first holes may be arranged at an interval in the first direction.

In this case, the plurality of the nozzles can preliminarily eject the liquid through the plurality of first holes.

The plurality of first holes may be arranged in a second direction perpendicular to the first direction.

In this case, the plurality of the nozzles can make the liquid, which has been preliminarily ejected, pass through the plurality of first holes.

The plurality of first holes ma be arranged in such a manner that each of the first holes is inclined with respect to the first direction.

In this case, the plurality of the nozzles can make the liquid, which has been preliminarily ejected, pass through the plurality of first holes.

The plurality of first holes may be arranged so as to partially overlapped one another in the first direction.

The liquid ejecting device may further comprise a receiver, opposed to the liquid ejecting head, and operable to receive the liquid which passes through the plurality of first holes.

In this case, it is possible with the receiver to reliably receive and recover the liquid, which has been preliminarily ejected from the nozzles and passed through the plurality of first holes.

The liquid ejecting device may further comprise a first pump, sucking the liquid received in the receiver, and a tank, storing the liquid sucked by the first pump.

In this case, the liquid, which has been recovered by the receiver, can be gathered and stored in the tank. It is possible to reliably recover the liquid so as not to be scattered.

The liquid ejecting device may further comprises a sucker operable to suck the medium to the transporter.

In this case, the medium can be reliably transported while the medium is sucked to the transporter without deviation.

The transporter may be provided with a plurality of second holes, and the sucker may include an air passage forming member which is disposed so as to correspond to the plurality of second holes, and a second pump which sucks the medium to the transporter through the plurality of second holes and the air passage forming member.

In this case, the transporter can transport the medium while reliably sucking the medium through the plurality of second holes of the transporter and the air passage forming member.

The plurality of first holes may be identical with the plurality of second holes.

The first pump may be identical with the second pump.

The first holes may be provided at least in an area different from an area of the transporter on which a medium having smallest width to be transported is mounted.

In this case, the plurality of the nozzles can preliminarily eject the liquid to the area of the transporter on which the medium having smallest width to be transported is mounted and to the plurality of first holes in the area except the area of the transporter on which the medium having smallest width to be transported is mounted. Besides, the necessity for providing the first holes over an entire width of the transporter is eliminated.

According to the invention, there is also provided a method of controlling liquid ejection in a liquid ejecting device, the method comprising:

providing the liquid ejecting head, having a plurality of nozzles which are operable to eject liquid toward a medium;

providing the transporter, operable to transport the medium relative to the liquid ejecting head in a first direction, and provided with a plurality of first holes adapted to receive the liquid that has been ejected toward outside of the medium; and

ejecting the liquid from the liquid ejecting head toward the plurality of first holes situated outside of the medium.

With this configuration, the nozzles of the liquid ejecting head can perform the preliminary ejection of the liquid through the plurality of first holes in the transporter. For this reason, it is not necessary for the nozzles to perform the preliminary ejection with respect to the medium, and there is no need for providing, in advance, an extra space for the preliminary ejection in the medium. It is possible to draw an image having a continuous design on a long medium, by employing the liquid.

The method may further comprise sucking the medium to the transporter through a second hole that is provided at the transporter.

In this case, the medium can be reliably transported while being sucked to the transporter.

The method may further comprise sucking the liquid that passes through the first holes by air flow.

In this case, it is possible to reliably recover the liquid so as not to be scattered.

The liquid may be cyclically ejected from all the nozzles in the liquid ejecting head irrespective of presence of the medium on the transporter.

In this case, there is no necessity for providing the first holes over the entire width of the transporter.

### BRIEF DESCRIPTION OF THE DRAWINGS

FIG. 1 is a perspective view showing an ink jet recording device, which is a preferred embodiment of a liquid ejecting device according to the invention.

FIG. 2 is a side view of the ink jet recording device in FIG. 1, as seen in a direction G.

FIG. 3 is a block diagram showing an electrical structure of the ink jet recording device in FIG. 1.

FIG. 4 is a perspective view showing an example of a line head and a liquid storage.

FIG. 5 is a perspective view showing a transport belt, air passage forming members, and a liquid receiver.

FIG. 6 is a perspective view showing the transport belt.

FIG. 7 is a sectional view showing a recording head, preliminary ejecting holes of the transport belt, and the liquid receiver.

FIG. 8 is a sectional view showing the transport belt, a medium, and the air passage forming member.

FIG. 9 is a flow diagram showing, as an example, a method of preliminarily ejecting liquid according to the invention.

FIG. 10 is a view showing a manner wherein preliminary ejecting ink is ejected through the preliminary ejecting holes in the embodiment according to the invention.

FIG. 11 is a view showing another embodiment of the invention wherein the preliminary ejecting holes are formed in the transport belt in a different manner.

FIG. 12 is a perspective view showing still another embodiment of the invention.

FIG. 13 is a sectional view showing as an example, a structure including the recording head, the preliminary ejecting holes in the transport belt, and the liquid receiver in the embodiment in FIG. 12.

FIG. 14 is a sectional view showing the liquid receiver in still another embodiment of the invention.

FIG. 15 is a perspective view showing the transport belt in a still another embodiment of the invention.

FIG. 16 is a view showing another embodiment of the invention wherein the preliminary ejecting holes are formed in the transport belt in a different manner.

FIG. 17 is a view showing a still further embodiment of the invention.

### DETAIL DESCRIPTION OF PREFERRED EMBODIMENTS

Now, a preferred embodiment of the invention will be described referring to the drawings.

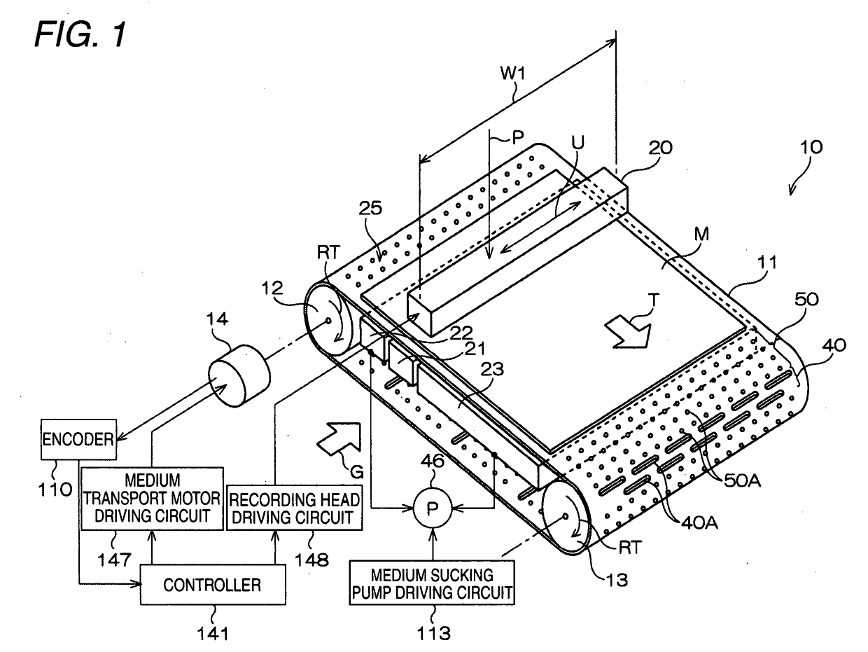

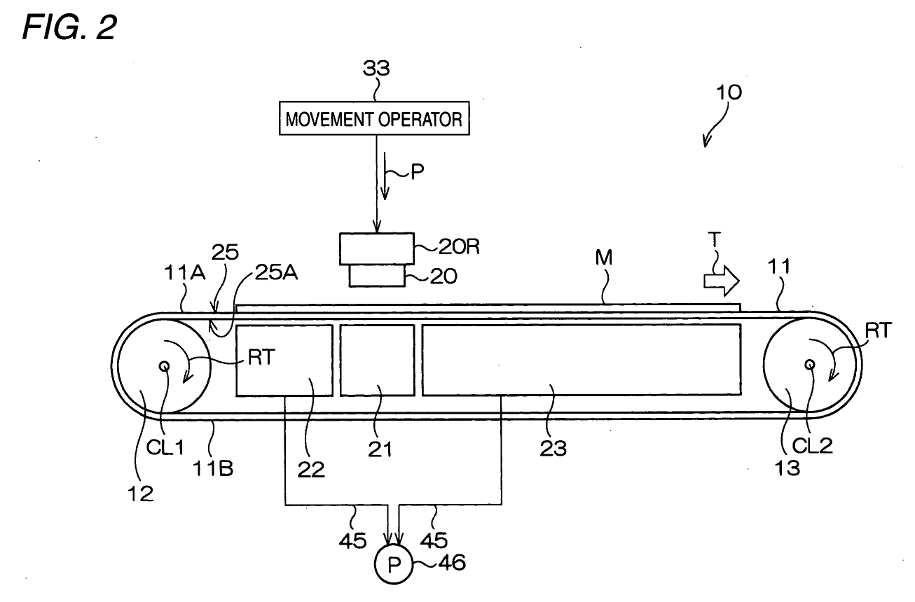

As shown in FIGS. 1 and 2, the ink jet recording device 10 (called also an ink jet printer) has a transport belt 11, a driving roller 12, a driven roller 13, a medium transport motor 14, a recording head 20, a liquid receiver 21, and air passage forming members 22, 23.

The transport belt 11 is endlessly wound around the driving roller 12 and the driven roller 13. The driving roller 12 is adapted to be driven so as to rotate in a direction RT, by actuation of the medium transport motor 14. The driving roller 12 and the driven roller 13 can move the transport belt 11 synchronously, by rotating it endlessly so as not to be displaced along a transport direction T. For this purpose, the transport belt 11 can be transported so as not to be displaced with respect to the driving roller 12 and the driven roller 13, by increasing tension of the transport belt 11, for example.

Alternatively, by employing a teethed belt as the transport belt 11, it is possible to transfer the transport belt 11 synchronously so as not to be displaced with respect to the driving roller 12 and the driven roller 13 of a sprocket type.

Anyway, it would be particularly desirable that the transport belt 11 can be transported so as not to be displaced with respect to the driving roller 12 and the driven roller 13.

Media M of various sizes are mounted on a mounting face 25 of the transport belt 11 and transported in the transport direction T by means of the transport belt 11. The mounting face 25 is an outer face side of the transport belt 11.

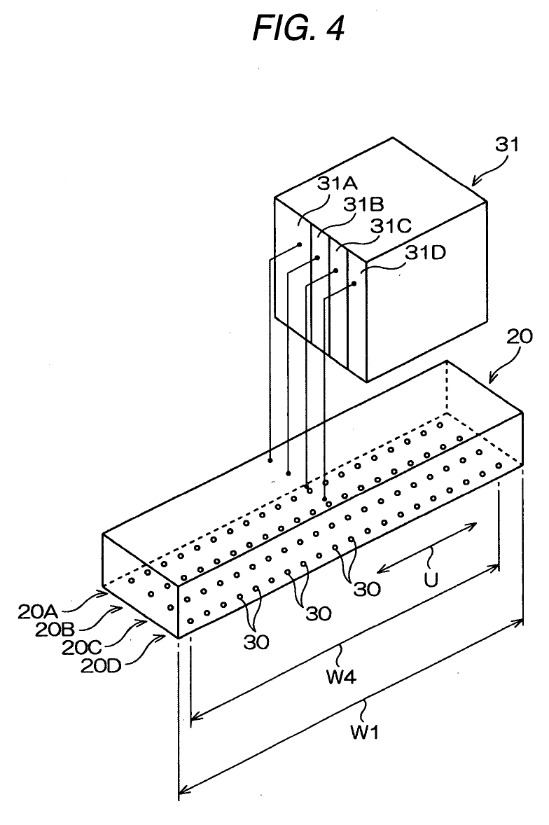

In FIGS. 1 and 2, the recording head 20 is arranged in an upper part so as to be opposed to the mounting face 25. The recording head 20 is a so-called line head. The recording head 20 has a plurality of nozzle rows 20A to 20D for ejecting inks of four colors separately, for example, as shown in FIG. 4. Each of the nozzle rows 20A to 20D has a plurality of nozzles 30. The nozzle rows 20A to 20D can be supplied with the inks from ink cartridges 31A to 31D of a liquid storage 31, for example. In this manner, the nozzle rows 20A to 20D of the recording head 20 can eject, for example, black ink, cyan ink, yellow ink, and magenta ink. However, it is of course natural that beside the inks of the four colors in total including the black ink, cyan ink, yellow ink, and magenta ink, the inks of more than five colors or one to three colors can be employed. Moreover, arrangement of the nozzle rows can be appropriately changed.

The recording head 20 can be positioned at a printing position P, as shown in FIGS. 1 and 2, by operating a movement operator 33 which is shown in FIG. 2, or can be retreated from the printing position P to an outside of a region of the transport belt 11.

Referring now to FIGS. 1, 5 and 6, examples of a shape of the transport belt 11 will be described.

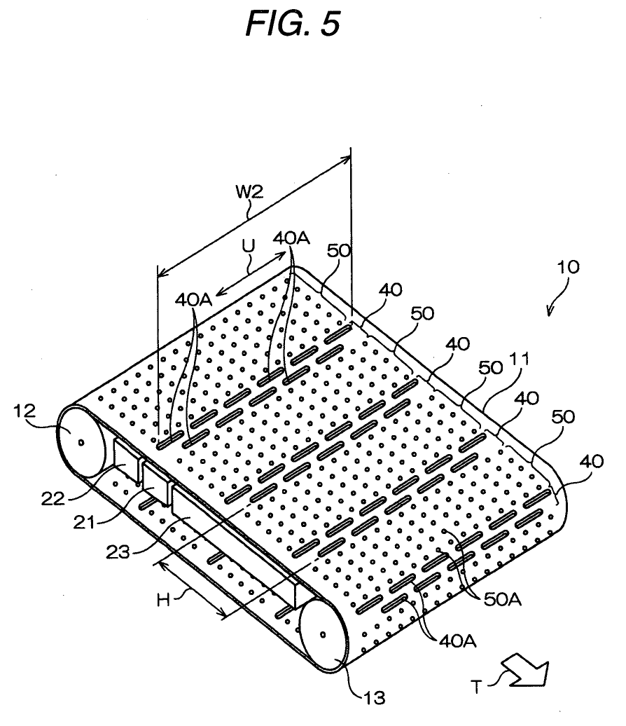

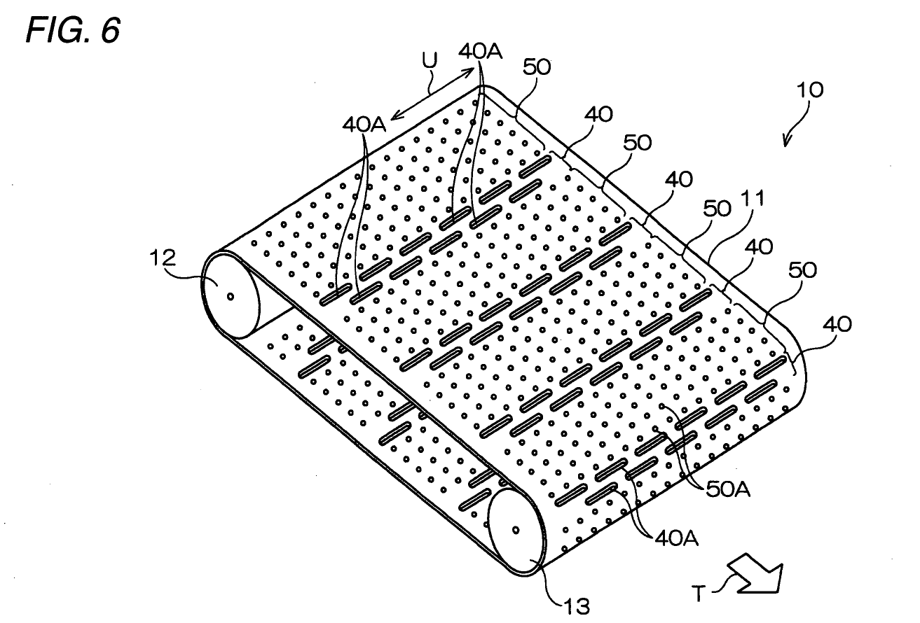

The transport belt 11 is an example of endless transporters, and has a plurality of groups 40 of preliminary ejecting holes and a plurality of groups 50 of sucking holes, as shown in FIGS. 5 and 6, for example.

As shown in FIG. 1, a width W1 in a direction U of the recording head 20, which is the line head, is set to be at least larger than or the same as a maximum width of the medium M. The plurality of the nozzles 30 of the recording head 20 as shown in FIG. 4 have an arranged width W4 in the direction U, which is slightly smaller than the width W1. The arranged width W4 of the plurality of the nozzles 30 in the direction U is substantially the same as an arranged width W2 of the group 40 of the preliminary ejecting holes as shown in FIG. 5, or slightly smaller than the arranged width W2. The group 40 of the preliminary ejecting holes includes a plurality of preliminary ejecting holes 40A corresponding to all the nozzles of the nozzle rows 20A to 20D which are shown in FIG. 4, for example.

The preliminary ejecting holes 40A are arranged in series and in parallel with the direction U which is perpendicular to the transport direction T Moreover, two rows of the adjacent preliminary ejecting holes 40A are formed in two rows, for example, in parallel with each other, along the direction U. These two rows of the preliminary ejecting holes 40A are opposed to the group 40 of the preliminary ejecting holes as shown in FIG. 5 and the nozzle rows 20A to 20D of the recording head 20 as shown in FIG. 4, so that they can receive all the preliminary eject liquid from the plurality of the nozzles 30 as shown in FIG. 4.

For example, there is formed a distance between the adjacent preliminary ejecting holes 40A in the first row, and the adjacent preliminary ejecting holes 40A in the second row are formed with a distance so as to compensate the distance in the first row. By staggering positions of the preliminary ejecting holes 40A in the first row and the second row along the direction U, in this manner, it is possible to secure rigidity of the belt more effectively than in case where the preliminary ejecting holes 40A in the second row are not staggered, or in case where large holes are formed along the width of the belt.

As shown in FIGS. 5 and 6, the groups 40 of the preliminary ejecting holes are formed in plurality at a determined interval along a longitudinal direction of the transport belt 11. Each of the preliminary ejecting holes 40A has an elongated elliptical shape, for example.

The groups 50 of the sucking holes are formed between the adjacent groups 40 of the preliminary ejecting holes. Each of the sucking holes 50A of the group 50 is a small hole in a round shape, for example, and is rather smaller than the preliminary ejecting hole 40A.

Both the preliminary ejecting hole 40A and the sucking hole 50A are through holes passing through the transport belt 11 in a direction of its thickness.

Then, the liquid receiver 21 and the air passage forming members 22, 23 as shown in FIGS. 1, 2 and 5 will be described.

The liquid receiver 21 is arranged at a position opposed to the recording head 20, as shown in FIGS. 1 and 2. The liquid receiver 21 is arranged just below the recording head 20 which is positioned at the printing position P, between an upper side 11A and a lower side 11B of the transport belt 11 as shown in FIG. 2. It is desirable that the liquid receiver 21 and the air passage forming member 22 may function also as a platen for bearing the upper side 11A of the transport belt 11.

In this manner, in case where the transport belt 11 is transported in the transport direction T, the upper side 11A can be stably supported from below by the liquid receiver 21 and the air passage forming member 22.

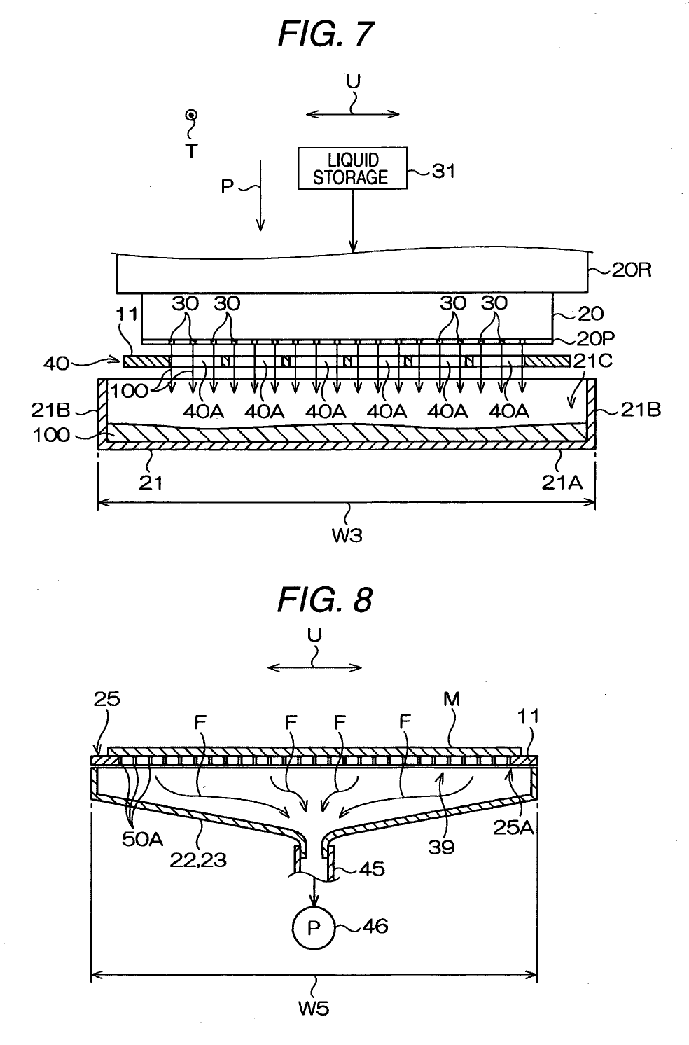

As shown in FIG. 7, the liquid receiver 21 has a width W3 which is preferably larger than the width of the transport belt 11 in the direction U. In this manner, the liquid receiver 21 can reliably recover the ink which has passed through the preliminary ejecting holes 40A. The liquid receiver 21 is a member in a shape of an elongate box, for example. The liquid receiver 21 has a bottom wall 21A and four side walls 21B, and an upper opening 21C is formed. This upper opening 21C is opposed to the preliminary ejecting holes 40A of the transport belt 11. Accordingly, the transport belt 11 is transported between a nozzle plate 20P of the recording head 20 and the upper opening 21C of the liquid receiver 21.

Preliminary ejecting ink 100 is preliminarily ejected from the nozzles 30 of the recording head 20. This preliminary ejecting ink 100 passes through the preliminary ejecting holes 40A of the transport belt 11 and the upper opening 21C of the liquid receiver 21 to be recovered into the liquid receiver 21.

This liquid receiver 21 is preferably detachably attached to the ink jet recording device 10. Therefore, when the liquid receiver 21 is filled with the preliminary ejecting ink 100, it is possible to detach the liquid receiver 21, and to attach a new liquid receiver 21 to the ink jet recording device 10.

Then, the air passage forming members 22, 23 as shown in FIGS. 1 and 2 will be described. The air passage forming members 22, 23 are respectively arranged at an upstream side and a downstream side of the liquid receiver 21 in the transport direction T.

FIG. 8 shows an example of a shape of the air passage forming members 22, 23. In FIG. 8, the air passage forming members 22, 23 are formed along the direction U, and have a width W5 which is substantially the same as the width of the transport belt 11 in the direction U. The air passage forming members 22, 23 are arranged on a lower face side of the upper side 11A of the transport belt 11 as shown in FIG. 2, so as to be opposed to the groups 50 of the sucking holes, as shown in FIG. 5. In other words, the liquid receiver 21 and the air passage forming members 22, 23 are arranged so as to be opposed to a lower face 25A which is an opposite face to the mounting face 25.

Each of the air passage forming members 22, 23 in FIG. 8 is a box-shaped member for forming air flows F, and has an upper opening 39, as shown in FIG. 8. This upper opening 39 is opposed to the lower face 25A of the transport belt 11. The air passage forming members 22, 23 are connected to a medium sucking pump 46 by way of a tube 45.

By actuating the medium sucking pump 46, air flows are created in the air passage forming members 22, 23. The air flows enable the medium M mounted on the mounting face 25 of the transport belt 11 to be reliably sucked to the mounting face 25 of the transport belt 11 through the sucking holes 50A. When the transport belt 11 is transported in the transport direction T as shown in FIGS. 1 and 2, the medium M can be transported by the transport belt 11 while it is reliably sucked.

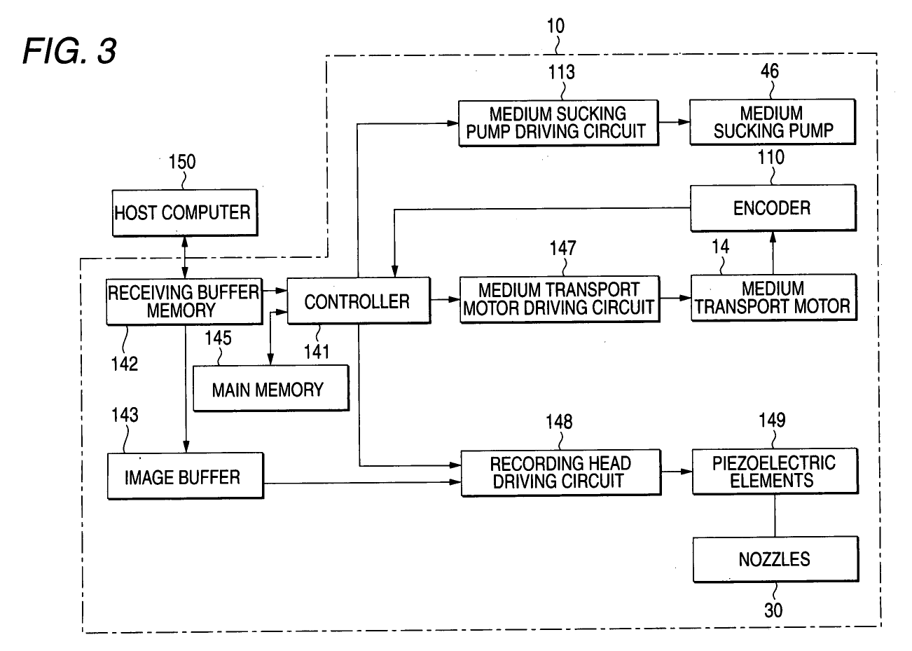

Now, referring to FIGS. 1 and 3, an example of a structure of electrical connection in the ink jet recording device 10 will be described.

As shown in FIG. 3, the ink jet recording device 10 has a controller 141, a receiving buffer memory 142, an image buffer 143, a main memory 145, a recording head driving circuit 148, a piezoelectric element 149, a medium transport motor driving circuit 147, a medium transport motor 14, an encoder 110, a medium sucking pump driving circuit 113, and a medium sucking pump 46.

The controller 141 controls an entirety of the ink jet recording device 10, thereby to communicate data of various kinds to and from a host computer 150, which is an exterior device, by way of the receiving buffer memory 142. Information of printing data received from the host computer 150 by way of the receiving buffer memory is decomposed by the controller 141, by each color component, into printing data having a plurality of the color components, and stored in the image buffer 143.

The controller 141 drives and controls the medium transport motor 14 by way of the medium transport motor driving circuit 147. When the medium transport motor 14 is driven, the transport belt 11 as shown in FIG. 1 can move in the transport direction T by means of the driving roller 12 and the driven roller 13. The controller 141 drives the piezoelectric elements 149 corresponding to the nozzles 30 which are shown in FIG. 4, by way of the recording head driving circuit 148. When the piezoelectric elements 149 are driven, the nozzles 30 ejects ink drops at a time of printing, or preliminarily ejects ink drops before printing.

The encoder 110 as shown in FIG. 3 detects rotation of the medium transport motor 14 thereby to send information of rotation amount SR to the controller 141. On the basis of this rotation amount information SR, the controller 141 can calculate a transported amount of the transport belt 11 in the transport direction T, as shown in FIG. 1.

The piezoelectric elements 149 of the nozzles 30 enable the ink to be preliminarily ejected from the nozzles 30, according to positions of the groups 40 of the plurality of the preliminary ejecting holes which have been obtained by the transported amount of the controller 141, in other words, according to a timing when the nozzles 30 of the recording head 20 are opposed to the preliminary ejecting holes 40A of the transport belt 11, as shown in FIG. 7.

As the encoder 110, an optical encoder, for example, can be employed.

The main memory 145 in FIG. 3 stores various programs to be conducted by the controller 141. The programs includes a program for decomposing the printing data from the host computer 150 by each color component into the printing data having a plurality of the color components and storing the printing data in the image buffer 143, and a program for driving the medium transport motor 14 and the piezoelectric elements 149 based on the printing data thereby to perform printing on the medium M. Further, there is a program for preliminarily ejecting the ink from the nozzles 30 at the timing when the nozzles 30 as shown in FIG. 7 are opposed to the preliminary ejecting holes 40A of the groups 40 of the preliminary ejecting holes of the transport belt 11, as described above.

The controller 141 in FIG. 3 drives and controls the medium sucking pump 46 by employing the medium sucking pump driving circuit 113. When the medium sucking pump 46 is driven, the medium M in FIG. 1 can be reliably sucked and held on the mounting face 25, through the sucking holes 50A, as already described.

Then, an example of a method of preliminarily ejecting liquid (a method of preliminarily ejecting ink) in the ink jet recording device 10 of the invention, as shown in FIG. 8, will be described.

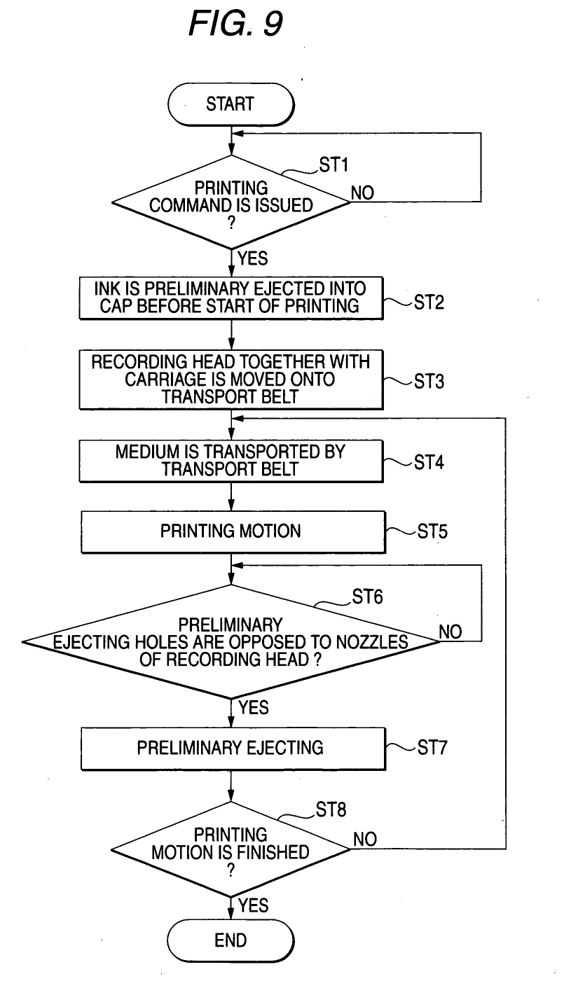

FIG. 9 shows steps ST1 to ST8.

Step ST1

In step ST1 in FIG. 9, whether or not a printing command has been issued from the host computer 150 to the controller 141 through the receiving buffer memory 142 is judged. In case where the controller 141 judges that the printing command has been issued, the controller 141 proceeds to step ST2.

Step ST2

In step ST2, the recording head 20 as shown in FIG. 1 is not at the position P. The recording head 20 is rotated by 90 degrees, for example, around an axis in a longitudinal direction thereof to be positioned outside the region of the transport belt 11, and the nozzles of the recording head 20 preliminary ejects the ink prior to start of the printing operation, into a cap which is not shown in the drawings.

Step ST3

In step ST3 in FIG. 9, the movement operator 33 as shown in FIG. 2 causes the recording head 20 to move together with a carriage 20R to the printing position P which is shown in FIGS. 1 and 2. Consequently, the recording head 20 is positioned at the printing position P as shown in FIG. 1. The movement operator 33 may include, for example, a guide rail, a belt, a motor and so on for moving the carriage 20R.

By operating the endless belt by actuating the motor, it is possible to move the recording head 20 and the carriage 20R from the position outside the region of the transport belt 11 to the printing position P as shown in FIG. 1.

Step ST4

In step ST4 in FIG. 9, the transport belt 11 is moved in the transport direction T, by actuating the medium transport motor 14 which is shown in FIG. 1, thereby to transport the medium M. In this case, the medium sucking pump 46 is operated to suck the medium M to be held on the mounting face 25 of the transport belt 11 through the air passage forming members 22, 23 and the plurality of the sucking holes 50A of the transport belt 11.

In this manner, the transport belt 11 can transport the medium M in the transport direction T while sucking it reliably without displacement.

Step ST5

In step ST5 in FIG. 9, when the controller 141 has issued the command for printing operation, the recording head driving circuit 148 in FIG. 3 gives a driving signal to the piezoelectric elements 149, whereby the ink is ejected from the desired nozzles 30. In this manner, it is possible to perform color printing, for example, on the medium M.

Steps ST6 and ST7

In step ST6 in FIG. 9, when the medium M as shown in FIG. 1 is transported in the transport direction T to reach the timing when the nozzles 30 of the recording head 20 at the printing position P are opposed to the group 40 of the preliminary ejecting holes, as shown in FIG. 7, the nozzles 30 preliminarily eject the preliminary ejecting ink 100. This preliminary ejecting ink 100 is recovered into the liquid receiver 21 through the respective preliminary ejecting holes 40A of the group in the transport belt 11. In other words, at the position corresponding to the printing position P of the transport belt 11, as shown in FIG. 7, the medium M is not mounted, but has already passed in the transport direction T in FIG. 7. In this state, the preliminary ejecting ink 100 which has been preliminarily ejected from the nozzles 30 can be directly recovered into the liquid receiver 21 through the preliminary ejecting holes 40A of the transport belt 11.

In this manner, the preliminary ejection in step ST7 in FIG. 9 is performed. In case where the preliminary ejecting holes 40A are not in a position opposed to the nozzles 30 of the recording head in step ST6, the printing operation and paper feeding operation are continued until the timing is reached, and then, preliminary ejecting the ink is conducted.

Step ST8

In step ST8 in FIG. 9, the controller 141 in FIG. 3 judges whether or not the printing operation has been finished. In case where the printing operation has not been finished, the procedure returns to step ST4, and steps ST4 to ST7 are repeated. When the printing operation has been finished, all the operations in the method of preliminarily ejecting liquid will be finished.

In the embodiment of the invention as shown in FIG. 1, the liquid receiver 21 which is a receiving member for the preliminary ejecting ink is opposed to the recording head 20 which is positioned at the printing position P.

A distance H between the adjacent groups 40 of the preliminary ejecting holes as shown in FIG. 5 is 100 mm, for example, in case where transporting speed of the medium M is 500 mm/sec. This distance H is measured along the transport direction T. The number of the preliminary ejection to be performed by the nozzles according to the distance is one to five shots per one second, for example. By performing the preliminary ejection in this manner, an increase in viscosity of the ink inside the nozzles of the recording head can be prevented. The medium transporting speed of the transport belt 11 in FIG. 5 along the transport direction T ranges from 500 mm/sec to 3000 mm/sec for example. It would be needless to say that the distance H between the groups of the preliminary ejecting holes, the number of the preliminary ejection, the medium transporting speed can be optionally or randomly selected according to various conditions such as kinds of the ink, the diameter of the nozzle of the recording head, material for the transport belt, and that substantially the same effects can be obtained even outside the range of the above described values.

The medium transferring speed of the transport belt 11 in FIG. 5 along the transport direction T ranges from 500 mm/sec to 3000 mm/sec for example.

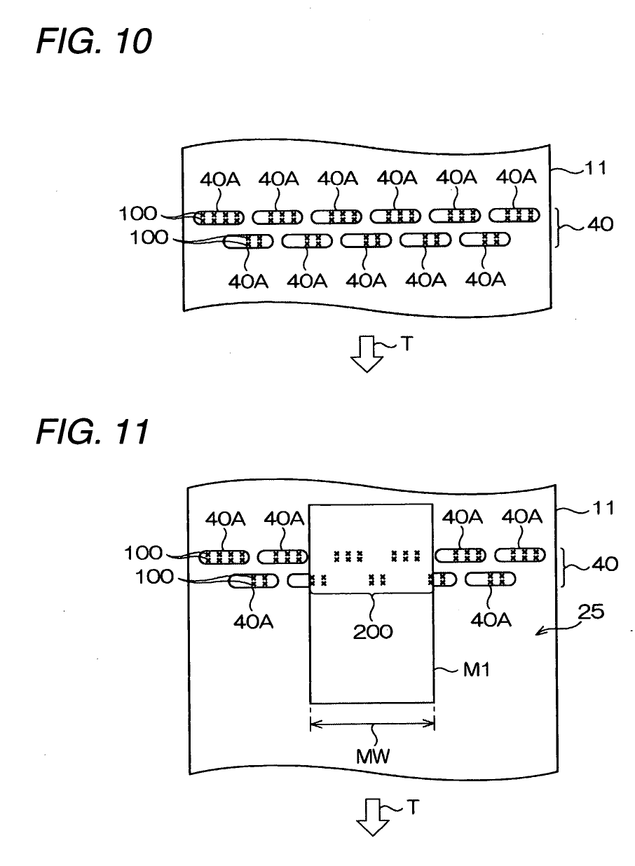

FIG. 10 shows, as an example, how the preliminary ejecting ink 100 is preliminarily ejected through the preliminary ejecting holes 40A of the transport belt 11 which are shown in FIG. 7.

Different from FIG. 10, FIG. 11 shows an example in which both the medium M1 and the preliminary ejecting holes 40A of the transport belt 11 are used to perform the preliminary ejection. In this example, the medium M1 has the smallest width MW. The medium M1 is transported in the transport direction T while being mounted on the mounting face 25 of the transport belt 11. In case where, among the media to be used, the medium M1 having the smallest width MW are used, the preliminary ejecting holes may not be provided in an area of the transport belt corresponding to the smallest width MW of the medium M1.

Then, the preliminary ejecting ink 100 is preliminarily ejected using both an area 200 to which the nozzles can preliminary eject the ink, outside the recording area of the medium M1, and the preliminary ejecting holes 40A of the transport belt 11 at both sides of the medium M1.

For this purpose, the groups 40 of the preliminary ejecting holes of the transport belt 11 are not formed in the area corresponding to the smallest width MW of the medium M1, but the preliminary ejecting holes 40A are formed in both side areas of the medium M1 so as to be slightly overlapped on the area corresponding to the smallest width MW of the medium M1.

In this manner, by using both the area 200 for the preliminary ejection outside the recording area of the medium Ml and the preliminary ejecting holes 40A which have been formed, in advance, in the transport belt 11, it is possible to perform the preliminary ejection. Because the preliminary ejecting holes 40A are formed so as to be slightly overlapped on the area corresponding to the smallest width MW of the medium M1, the preliminary ejecting ink can be ejected, without problem, to the medium M1 or the preliminary ejecting holes 40A even from the nozzles overlapping on edge portions of the medium M1. According to the structure of the transport belt 11, the groups 40 of the plurality of the preliminary ejecting holes need not be formed across the entire width of the transport belt 11.

However, this is not necessarily the case, but it is possible to arrange the edge portions of the medium Ml at marginal positions, without overlapping the medium M1 on the preliminary ejecting holes 40A, provided that the paper width of the medium M1 has been detected in advance.

Other Embodiments of the Invention

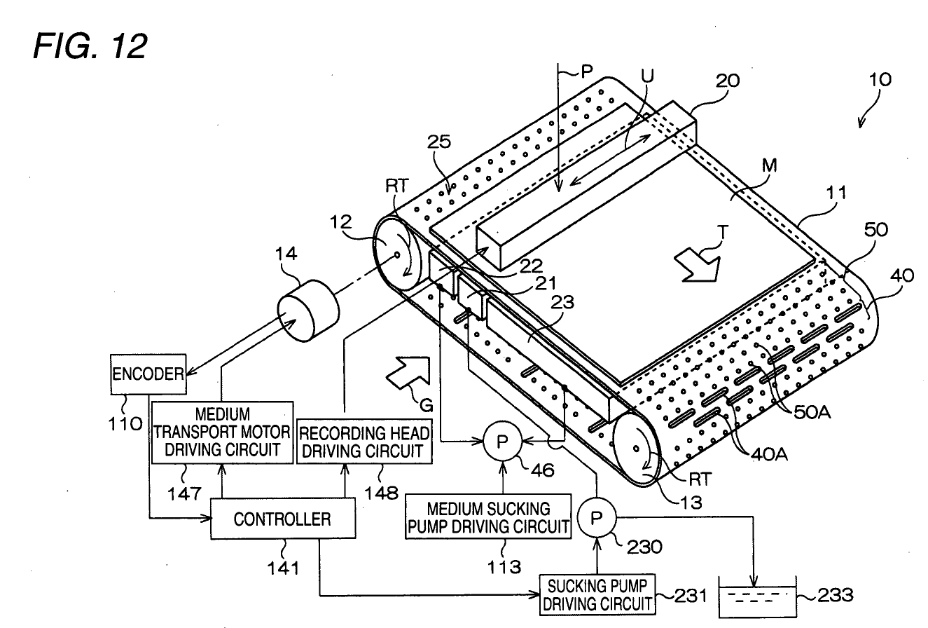

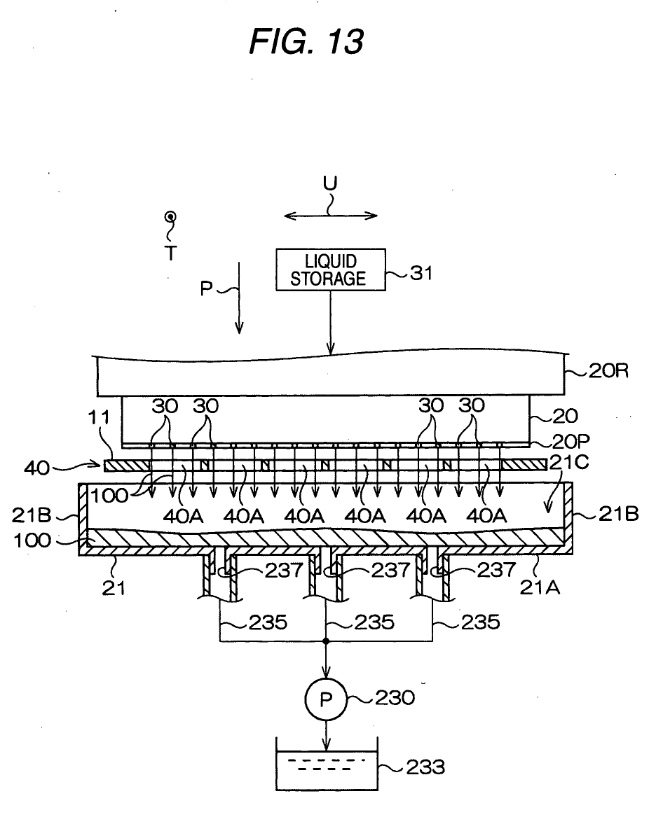

FIGS. 12 and 13 show another embodiment of the invention.

The embodiment in FIGS. 12 and 13 is different from the embodiment in FIG. 1 in that the liquid receiver 21 is connected to a suction pump 230. The controller 141 drives and controls the suction pump 230 by way of a suction pump driving circuit 231. When the suction pump 230 is driven and controlled, the preliminary ejecting ink is recovered into the liquid receiver 21, and the preliminary ejecting ink can be ejected to a waste liquid tank (liquid tank) 233 through the suction pump 230 to be recovered.

As shown in FIG. 13, the liquid receiver 21 is connected to the suction pump 230 by way of tubes 235. Respective one ends of these tubes 235 are connected to connecting portions 237 in the bottom wall 21A of the liquid receiver 21.

Because the suction pump 230 can suck the preliminary ejecting ink 100 in the liquid receiver 21, the following merit can be obtained. Specifically, in case where the preliminary ejecting ink 100 which has been preliminarily ejected from the nozzles 30 is directly recovered into the upper opening 21C of the liquid receiver 21 through the preliminary ejecting holes 40A of the transport belt 11, the suction pump 230 can suck the ink in a manner of forming an air flow, and therefore, the preliminary ejecting ink 100 can be recovered so as not to be scattered as mist. It is to be noted that the medium sucking pump may be co-used as the suction pump, and the suction pump may be driven by the same driving source as that of the medium sucking pump.

Because other constituent elements in the embodiment in FIGS. 12 and 13 are the same as the corresponding constituent elements in FIGS. 1 and 7, the same reference numerals are given to the elements and the same description is employed.

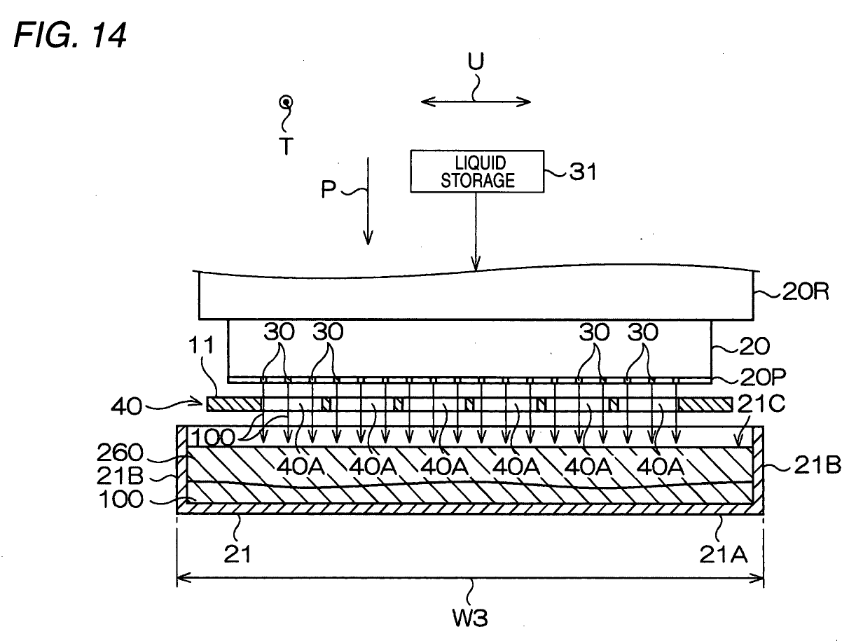

FIG. 14 shows still another embodiment of the invention.

As compared with the embodiment as shown in FIG. 7, the embodiment in FIG. 14 is different in that absorbing material 260 is disposed in the liquid receiver 21. This absorbing material may include, for example, expanded plastic or sponge which can absorb the preliminary ejecting ink 100. By employing such absorbing material 260, it is also possible to prevent the preliminary ejecting ink 100 from being scattered, after it has passed through the preliminary ejecting holes 40A of the transport belt 11. Because other constituent elements in the embodiment in FIG. 14 are the same as the corresponding constituent elements in the embodiment in FIG. 7, the same reference numerals are given to the elements and the same description is employed.

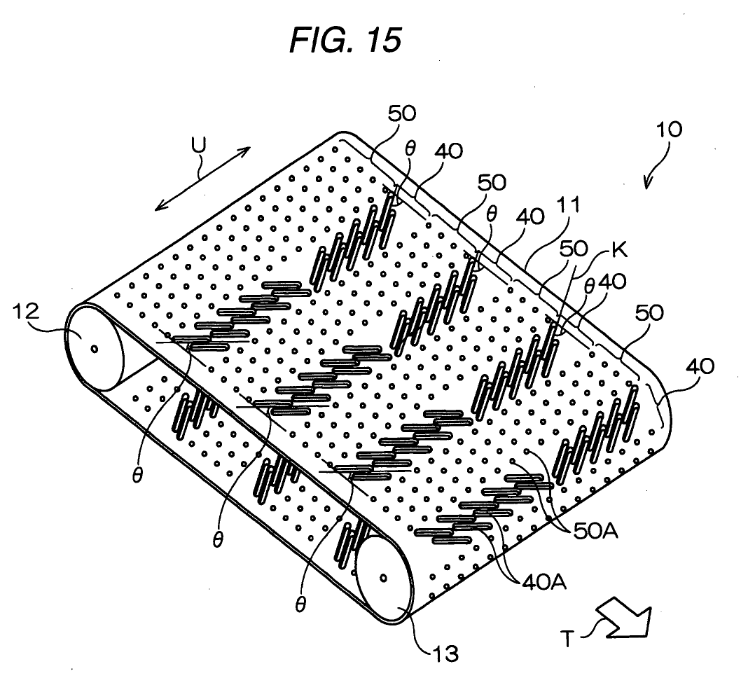

FIG. 15 shows a further embodiment of the invention.

In the embodiment in FIG. 15, the preliminary ejecting holes 40A in the group 40 of the preliminary ejecting holes formed in the transport belt 11 are oriented in a different direction from those in the embodiment as shown in FIG. 5. In the embodiment in FIG. 15, a longitudinal direction K of the preliminary ejecting holes 40A is inclined at an angle 0 with respect to the transport direction T. In this manner, it is of course possible to form the preliminary ejecting holes 40A at an angle with respect to the transport direction T in their longitudinal direction, different from the case in the embodiment in FIG. 5. Consequently, the rigidity of the belt can be secured.

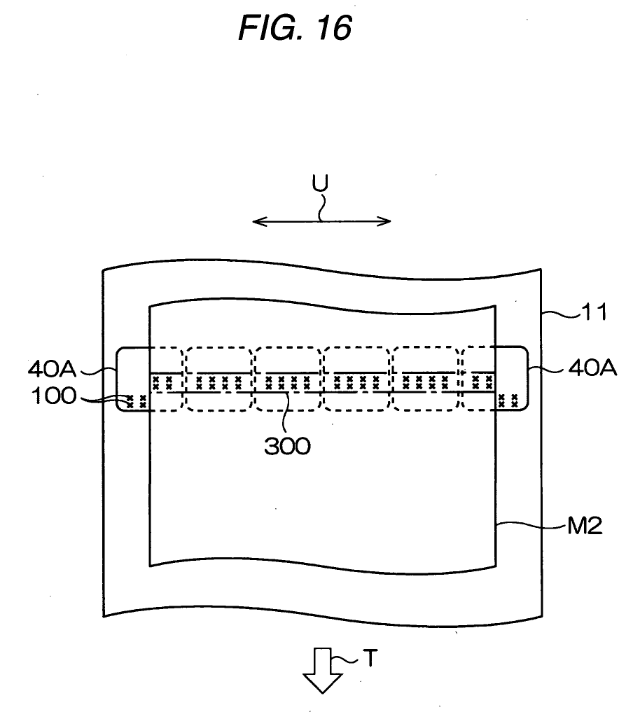

FIG. 16 shows a still further embodiment of the invention.

In the embodiment in FIG. 16, the plurality of the preliminary ejecting holes 40A are formed in the direction U, in the transport belt 11. In the embodiment in FIG. 16, the preliminary ejecting holes 40A in a rectangular shape, for example, are formed in series in the direction U. In case where the medium M2 is transported in the transport direction T, the preliminary ejecting ink 100 from the nozzles which are positioned outside the medium M2 are preliminarily ejected, in advance, to the preliminary ejecting holes 40A in the transport belt 11.

Immediately after that, when an area 300 outside the data forming area of the medium M2 is positioned just below the recording head, the remaining nozzles of the recording head eject the preliminary ejecting ink 100 to the area 300 outside this data forming area.

In this manner, it is possible to preliminarily eject the preliminary ejecting ink 100 to below the transport belt 11 through the preliminary ejecting holes 40A, and also to the area 300 outside the data forming area of the medium M2.

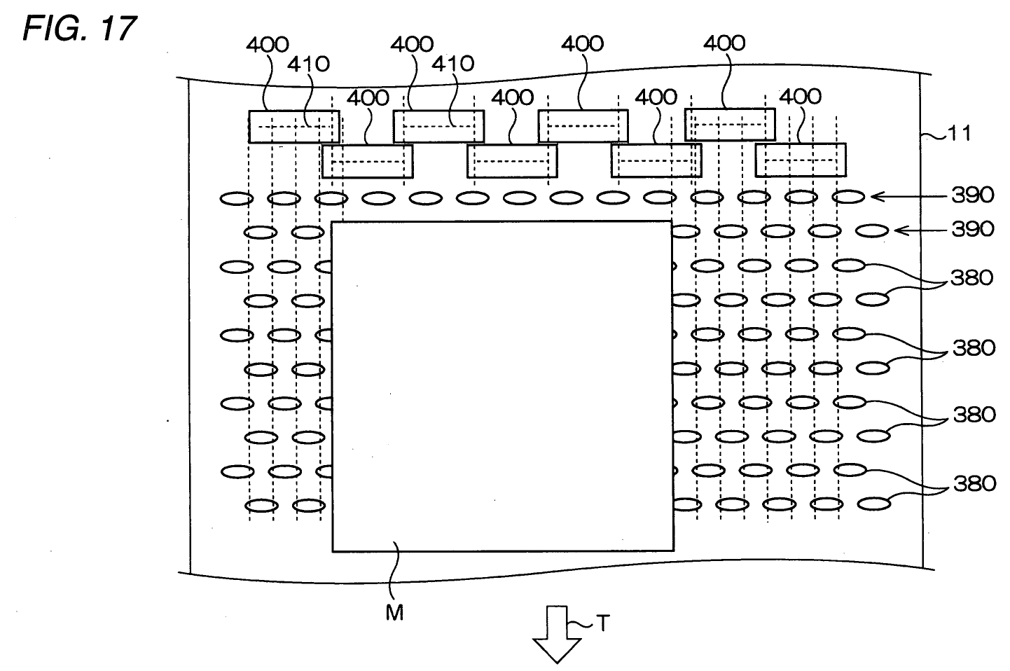

FIG. 17 shows a still further embodiment of the invention.

In FIG. 17, the transport belt 11 has a plurality of common holes 380. The common holes 380 are formed in rows 390 in a direction perpendicular to the transport direction T, and the rows 390 of the common holes 380 are arranged along the transport direction T in parallel with each other. The common holes 380 in the adjacent rows 390 are staggered from each other so as to be overlapped. The common hole 380 is characterized in that it may be commonly used as the sucking hole and the preliminary ejecting hole for flushing.

In this manner, because the common holes 380 are overlapped in a lateral direction, all the nozzles in heads 400 can preliminarily eject the preliminary ejecting ink through either of the common holes 380. Although the heads 400 are arranged in a horizontal direction in FIG. 17, the heads 400 may be arranged in a diagonal direction.

A plurality of the heads 400 can be employed in place of the line head, and they are arranged so as to be staggered from each other. Although there is a single nozzle row 410 in each of the heads 400 in the illustrated embodiment, this is not necessarily the case, but the nozzles may be arranged, for example, in four rows along the transport direction T

In the embodiments of the invention, the nozzles of the line head can preliminarily eject the liquid through the plurality of the preliminary ejecting holes in the transporter. For this reason, there is no need for preliminarily ejecting the liquid to the medium from the nozzles of the line head, nor need for providing, in advance, an extra space in the medium for the preliminary ejection. Therefore, it is possible to print a drawn image having a continuous design on a long medium, by ejecting the liquid.

In the embodiments of the invention, the liquid which has been preliminarily ejected from the nozzles and passed through the plurality of the preliminary ejecting holes can be reliably received by the liquid receiver to be recovered. The liquid which has been recovered by the liquid receiver can be gathered and stored in the liquid tank. In this manner, it is possible to reliably recover the liquid so as not to be scattered. The transporter can transfer the medium, by more reliably sucking them through the plurality of the sucking holes and the air passage forming members. The plurality of the nozzles can preliminarily eject the liquid to the area corresponding to the smallest width of the medium and the plurality of the preliminary ejecting holes which are provided outside the area.

In the embodiments of the invention, the transport belt 11 has such a structure that the media M are sucked in a so-called suction sucking method to be transported.

However, this is not necessarily the case, but it is of course possible to construct the transport belt 11 in such a manner that an electrode is incorporated therein, for example, and the medium M is sucked to the mounting face of the transport belt 11 in an electrostatic sucking method to be transported. The transport belt need not be an endless belt.

In the embodiments of the invention, the transport belt is provided with the sucking holes so that the medium can be accurately and reliably transported while being sucked. Because the plurality of the sucking holes are formed at a determined interval in the transport belt, it is possible to accurately transport the medium while sucking it substantially uniformly over the entire face of the medium.

In the embodiments of the invention, the preliminary ejection from the nozzles are performed synchronously with the positions of the preliminary ejecting holes of the transport belt.

In the embodiments of the invention, printing can be performed by the line head, while the medium is transported by the transport belt. The nozzles can perform the preliminary ejection successively and at the required timings, while the nozzles are aligned with the preliminary ejecting holes of the transport belt.

In the embodiments of the invention, it is not necessary to particularly provide the medium with the extra spaces required for the preliminary ejection. The nozzles can perform the preliminary ejection through the preliminary ejecting holes of the transport belt, at the timing when the preliminary ejecting holes are opposed to the nozzles. Therefore, printing can be performed on the medium such as paper of various types with no regard to the width (the width in a direction perpendicular to the transport direction) of the medium. Moreover, it is also possible to print a continuous data on the medium which is long in the transport direction, without interruption.

Although paper is mentioned as the medium M in the embodiments of the invention, it is of course possible to employ a recording medium of other types than paper.

The invention is applied not only to the ink jet recording device, but also to a recording head employed in an image recording device such as a printer, a color material ejection head employed for manufacturing a color filter of a liquid display or the like, an electrode material ejection head employed for forming an electrode of an organic EL display, FED (face emitting display) or the like, a liquid ejecting device employing a liquid ejection head which ejects liquid, such as bioorganic material ejection head used in manufacture of biochips, a sample ejecting device as a precision pipette, and so on.

The present invention is not limited to the above described embodiments, but various modifications can be made in a scope not deviated from the scope of the claims.

Those components in the above described embodiments can be partly omitted, or may be assembled optionally in a different form from the above described.

What is claimed is:

1. A liquid ejecting device comprising:
a liquid ejecting head, having a plurality of nozzles which are operable to eject liquid toward a medium;
a transporter operable to transport the medium relative to the liquid ejecting head in a first direction, wherein
the transporter is provided with a plurality of first holes adapted to receive the liquid that has been ejected toward outside of the medium.

2. The liquid ejecting device according to claim 1, wherein
the plurality of first holes are arranged at an interval in the first direction.

3. The liquid ejecting device according to claim 2, wherein
the plurality of first holes are arranged in a second direction perpendicular to the first direction.

4. The liquid ejecting device according to claim 2, wherein
the plurality of first holes are arranged in such a manner that each of the first holes is inclined with respect to the first direction.

5. The liquid ejecting device according to claim 2, wherein
the plurality of first holes are arranged so as to partially overlapped one another in the first direction.

6. The liquid ejecting device according to claim 1 further comprising,
a receiver, opposed to the liquid ejecting head, and operable to receive the liquid which passes through the plurality of first holes.

7. The liquid ejecting device according to claim 6 further comprising,
a first pump, sucking the liquid received in the receiver, and
a tank, storing the liquid sucked by the first pump.

8. The liquid ejecting device according to claim 6 further comprising,
a sucker operable to suck the medium to the transporter.

9. The liquid ejecting device according to claim 8, wherein
the transporter is provided with a plurality of second holes, and
the sucker includes an air passage forming member which is disposed so as to correspond to the plurality of second holes, and a second pump which sucks the medium to the transporter through the plurality of second holes and the air passage forming member.

10. The liquid ejecting device according to claim 9, wherein
the plurality of first holes are identical with the plurality of second holes.

11. The liquid ejecting device according to claim 9, wherein
the first pump is identical with the second pump.

12. The liquid ejecting device according to claim 1, wherein
the first holes are provided at least in an area different from an area of the transporter on which a medium having smallest width to be transported is mounted.

13. A method of controlling liquid ejection in a liquid ejecting device, the method comprising:
providing the liquid ejecting head, having a plurality of nozzles which are operable to eject liquid toward a medium;
providing the transporter, operable to transport the medium relative to the liquid ejecting head in a first direction, and provided with a plurality of first holes adapted to receive the liquid that has been ejected toward outside of the medium; and
ejecting the liquid from the liquid ejecting head toward the plurality of first holes situated outside of the medium.

14. The method according to claim 13 further comprising,
sucking the medium to the transporter through a second hole that is provided at the transporter.

15. The method according to claim 13 further comprising,
sucking the liquid that passes through the first holes by air flow.

16. The method according to claim 13, wherein
the liquid is cyclically ejected from all the nozzles in the liquid ejecting head irrespective of presence of the medium on the transporter.
